(19) United States
(12) Patent Application Publication
(10) Pub. No.: US 2011/0246581 A1
(43) Pub. Date: Oct. 6, 2011

(54) Method and System for Group Event Communications

(75) Inventors: Zhongwen Zhu, Saint-Laurent (CA); Daniel Dufour, Blainville (CA); Andre Godin, Laval (CA)

(73) Assignee: TELEFONAKTIEBOLAGET L M ERICSSON (PUBL), Stockholm (SE)

(21) Appl. No.: 12/750,200

(22) Filed: Mar. 30, 2010

(51) Int. Cl. G06F 15/16

(52) U.S. Cl. 709/206; 709/230

(57) ABSTRACT

A method and an Event Tracking System (ETS) are provided for group communications. The method allows subscribing with an Event Organizing System (EOS) for updates to a group event instance comprising a group of users and an event related to the group, e.g. a hockey match. The method further allows receiving from users subscriptions to the updates of the group event instance. Responsive to subscribing with the EOS for the updates to the group event instance, the ETS receives from the EOS an update notification related to the group event instance notifying of a group event update (e.g. an update of the group membership and/or of the event), and responsive to the user subscriptions with the ETS, the later sends out an update notification message to each one of the users notifying of the group event update. In one embodiment, the update notifications sent out to users are personalised, e.g. based on the user's location or advertisement preferences.

### TECHNICAL FIELD

The present invention relates to a method and system for providing group communications.

### BACKGROUND

One-to-one and one-to-many communications are known for some time already. One-to-many communications involve, for example, emails or other types of messages sent by one user to a plurality of other users. Other examples of such technologies include but are not limited to Short Messaging Service (SMS), Multimedia Messaging Service (MMS), and Instant Messaging (IM). Conference calls further complement the above-mentioned once-to-many communications by providing a means for one-to-many voice-based communications.

With the event of mobile communications and of the IP Multimedia Subsystem (IMS), the new challenge of telecommunication stakeholders is to find the optimal manner to best serve the public with the provision of efficient group communications. Such group communications are important for example to network operators as they involve multiple users each of whom makes usage of network resources and therefore being a source of revenue for the network operators. Likewise, group communications are also important to the end-users, who see in such type of communications a manner of experiencing group proximity without the need of being physically co-located with friends or family. Applications of group communications are virtually unlimited. They may be used in business environments where teams need to collaborate or for personal usage where family or friends need to exchange personal information, e.g. the setup of a hockey tournament, inform about a friendly gathering, exchange personal messages or media, etc.

Network operators, for example, are continuously looking into providing more and more appealing group communication services to end users in order to increase network usage and thus profitability. In this context, IMS provides an opportunity to capitalize on the desire of people for group communications. IMS offers the possibility of having an integrated network of telecommunications carriers consolidating the use of IP for packet based communications in various forms. IMS provides a basis for traditional telephony, Internet access, Web Services, Voice over IP (VoIP), and various types of messaging, including IM, Multimedia Messaging conferencing service, presence service, and location based services.

IMS provides also a framework where users can subscribe to information updates related to other users or to pre-defined events. However, current IMS implementations do not allow an IMS user to seemingly and easily participate in a group communication application that not only allows the subscriber to obtain access to specific information updates, but also to communicate with other end users who might have subscribed to the same specific information update.

One illustrative example of the limitations of current IMS system is the problem of organizing events, e.g. sport events, involving multiple participants and propagating information and updates regarding such events to the participants. The challenges of such a setup include how to have a group of users being notified of the event information update, how to inform the users associated with the event about changes in time or location of the event, and how to allow the users associated with the given event to communicate with each other without necessarily knowing each others coordinates (e.g. phone numbers or email addresses). There is no current known IMS setup that can positively answer to these challenges.

Accordingly, it should be readily appreciated that in order to overcome the deficiencies and shortcomings of the existing solutions, it would be advantageous to have a method and system providing for effective and simple group communications.

### SUMMARY

In one aspect, the present invention is a method for group communications comprising the step of subscribing with an Event Organizing System (EOS) to updates of a group event instance, the group-event instance comprising identification of a group of users and an event related to the group of users, said updates comprising changes to information related to the group event instance. The method further comprises the steps of receiving from at least certain users subscriptions to the updates of the group event instance. Responsive to step the subscription with the EOS, the method further allows for receiving from the EOS an update notification related to the group event instance notifying of a group event instance update, and responsive to receiving from the users subscriptions to the updates of the group event instance, the method allows for sending out an update notification message to at least the certain users notifying of the group event update.

In another aspect, the present invention is an Event Tracking System (ETS) comprising a data repository comprising group event instances, wherein each group event instance comprises an identification of a group of users, and an event related to the group of users; and a communications interface operationally connected to the data repository and supporting communications with external nodes, the interface receiving, from at least certain users of a group, subscriptions for updates to a corresponding group event instance and, responsive thereto, sending out an update notification message to the certain users notifying of an update related to the group event instance.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a high level network diagram of an exemplary preferred embodiment of the invention;

FIG. 2 is a nodal operation and signal flow diagram illustrative of an exemplary implementation of the preferred embodiment of the invention;

FIG. 3.a is a high level exemplary illustration of a group event instance according to the preferred embodiment of the invention;

FIG. 3.b is a high level block diagram of an exemplary implementation of the EOS (Event Organizing System) according to the preferred embodiment of the invention; and

FIG. 4 is a high level block diagram of an exemplary implementation of the ETS (Event tracking System) according to the preferred embodiment of the invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides for a new method and system for offering personalized group communication services to groups of users. According to an exemplary embodiment of the invention, there are provided telecommunications nodes that comprise group event instances for facilitating group communications. In the context of the present invention, the association of a group of users with event information (e.g. an event such as a hockey game, a gathering, or a party) defines a so-called group event instance since it contains information related to a group of users associated with a given event. A group event can also comprise information associating one or more user groups with one or more events. Such a setup may facilitate users of a given group being notified of group event updates (e.g. a change of time or place of a given event is propagated to users belonging to the group event). According to another exemplary embodiment of the invention, there is provided a novel 2-tier event tracking service based on IMS services that takes advantage of the proposed group event instance. The proposed exemplary embodiment not only provides for end users to subscribe to receive updates regarding specific group events but facilitates communication among end users having subscribed to the same group event. The present invention proposes a solution that makes use of the 2-tier structure using the concept of IM and conferencing services as well as the SIP (Session Initiation Protocol) SUBSCRIBE-NOTIFY mechanism in order to allow updates to the group event (such as for example a change in the group of users or a change in the event definition such as the place or time or the event) to be propagated to users and further allows the later to communicate with each other. This provides for seamless update notifications of group event information to be sent to all concerned users, which may trigger communication among the users themselves, and thus, not only provide an added value for end-users, but also increasing network usage which is beneficial for the network operators. The 2-tier system proposed by the exemplary embodiment of the invention comprises an Event Organizer Service (EOS), and second an Event Tracker Service (ETS). The later service can also be integrated with, or connected to, various other service servers, such as for example a Location Update Service Server, a map guide/GPS service, an advertisement service server, etc, in order to allow for a personalization of update notifications sent out to the end users based on their location, or based on their advertisement preferences, in a manner that is yet to be described. The EOS, in turn, is responsible for publishing information related to a group event so that end-users get access to the EOS' address and available events, in order to be able to join in such events, associate users or user groups to the events, and in this manner create new group events. Users are then also able to update group events instances, while the combination of EOS and ETS act upon such group event updates to propagate them to other interested users.

The ETS, on its part, is provided in order to facilitate the end users' subscriptions to specific group events instances (also called herein simply group events) and to ease the communication with other end users associated with the same group event. Whenever the EOS updates the information related to a certain group event, the associated ETS instance gets notified of the EOS update, which in turn notifies each user associated with the group event. Also, whenever an end user wants to communicate with other end users of the certain group event, he or she can simply send a message to the corresponding group event instance of the ETS, which will result in the ETS distributing the message to all users associated with the group event.

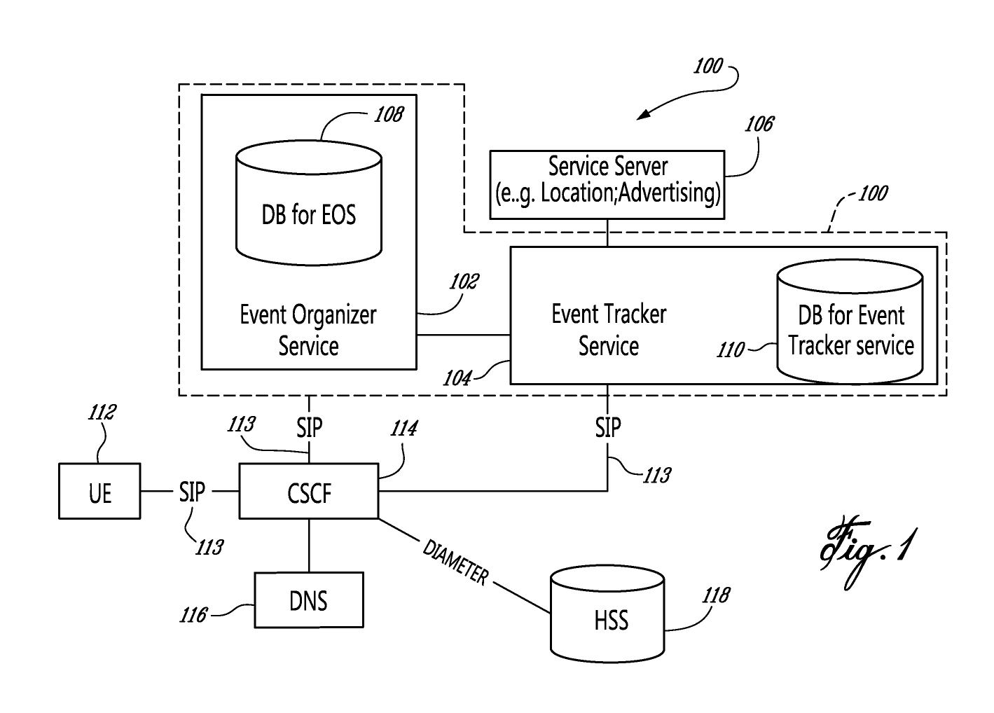

Reference is now made to FIG. 1, which is a high level network diagram of an exemplary preferred embodiment of the invention. Shown in FIG. 1, are first components or an IMS network 100, including a User Equipment (UE) 112 in communication via a Session Initiation Protocol (SIP) communication interface with a Call State and Control Function (CSCF) 114, which has access to a Domain Name Server (DNS) 116, and to a Home Subscriber Server (HSS) 118. The roles of these nodes are well known in IMS and will thus not be further described. The CSCF 114 has further access via SIP communication interfaces 113 to the EOS 102 and to the ETS 104 as provided by the exemplary preferred embodiment of the invention. The EOS 102 may comprise a data repository 108 storing group event instances. Each group event instance may include one or more groups of users, each including a plurality of users, and event information (i.e. one or more events) associated with each group, such as for example the type, name, time, and location of the event. For example, a group event instance may comprise a user group identified by a group identifier (and optionally comprising also the identities of the users associated with the group e.g. phone numbers, email addresses, URI addresses, or the like) and one or more events, e.g. a hockey match associated with the group, along with its time and place: type=hockey match, time=10:00 PM, location=1234 Hockey Blvd, 90210). The ETS 104 also includes a data repository 110 that also stores its own version of the group event instances. In the network 100, a group event instance is first created in the EOS 102, e.g. by an event organizer, such as for example a hockey team coach, by associating a group of users (e.g. the hockey team members) with a given event (e.g. a hockey match at place X and time Y). The EOS 102 notifies the ETS 104 of the group event creation, so that the ETS creates its own group event instance, that will be updated every time the EOS's corresponding instance is itself updated with new information (e.g. a change in place or time of the event, a change in the group membership, etc). When the ETS is notified of such a change, it further notifies the end users associated with its own the group event instance. The ETS 104 may be in communication with a Service Server 106, such as for example a Location Guide Service (LGS) or an advertisement server, responsible for personalizing notifications to users, such as for example based on the user's location information or advertisement preferences. The operation of the network shown in FIG. 1 will be more apparent with the further description.

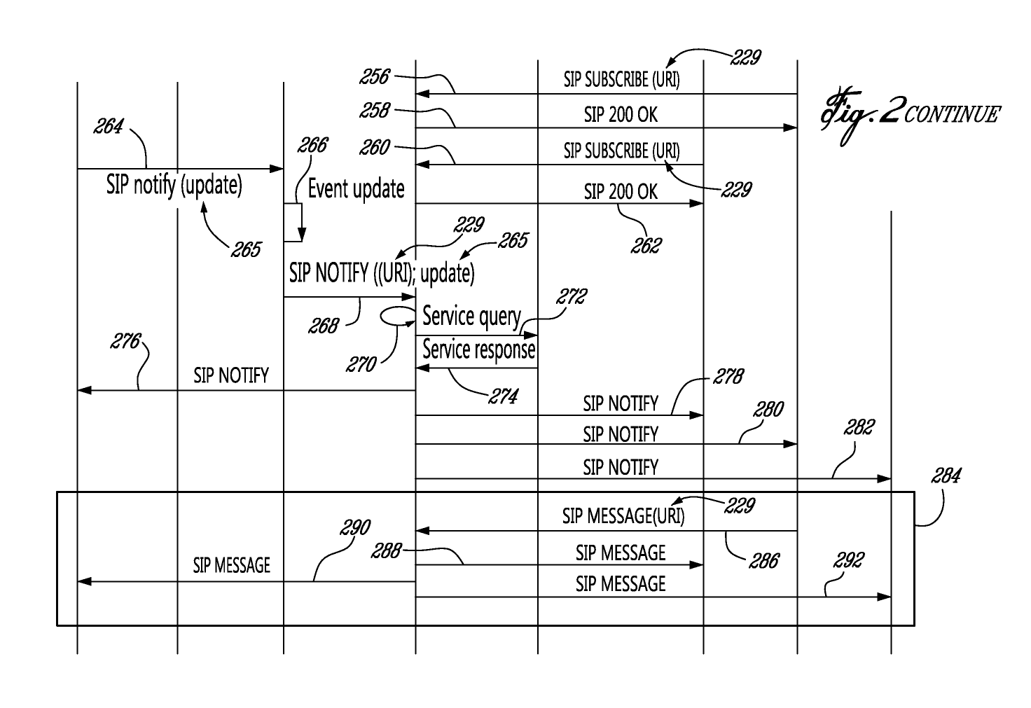

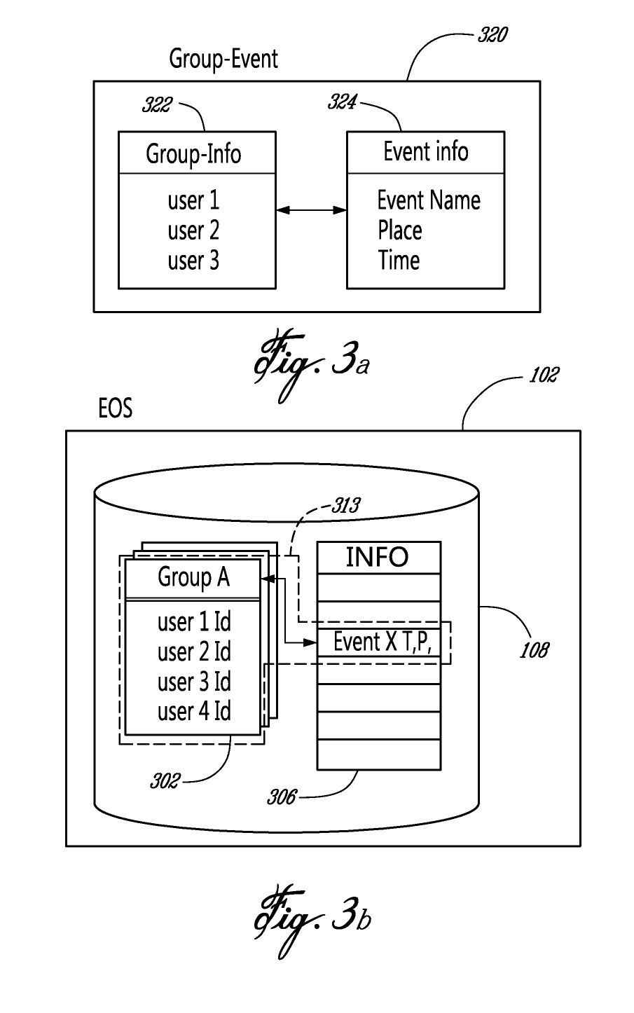

Reference is now made to FIG. 3.a which is a high level exemplary illustration of a group event instance 320 according to the preferred embodiment of the invention. The group event instance 320 may be stored in any type of data repository (e.g. memory, RAM, ROM, database, etc) of the EOS or of the ETS and comprise user group information 322 and event information 324. Shown in FIG. 3.a comprised in the group event instance 320 is group information 322 comprising a user group with a plurality of users, represented preferably by their user identities 1, 2, and 3, and the event information 324 that may comprise any type of information related to a given event, such as for example the event name, the event place and the event time. Although FIG. 3.a shows a group event instance containing both the group information 322 and the event information 324, it is to be understood that those can also be stored in different data repositories but still have a link therebetween. In the context of the present invention it is understood that any relation or link between at least a user group and at least an event composes a group event instance, independently of the place the user group and the event information are stored (e.g. co-located or separated) or linked.

Reference is now made to FIG. 3.b which shows a high level block diagram of an exemplary implementation of the EOS 102 according to the preferred embodiment of the invention. Comprised in the EOS 102 is the data repository 108 comprising group event instances including user groups and events. The data repository 108 comprises one or more user groups 302 typically containing a group name and optionally a list of users that are part of the given group. For example, shown as being part of group A are users 1-2-3-4. Also present in the data repository 108 is event information X that is associated with group A. In a real-life example, group A may be a hockey team or a group of friends playing hockey together, and the event X may comprise reference to an event name, e.g. “Next Hockey Match”, and to event's time and place, such as for example a time T and place P where the next hockey match takes place. The association of the group A and event information defines the group event instance 313 since it contains information related to both a group of users and a given event.

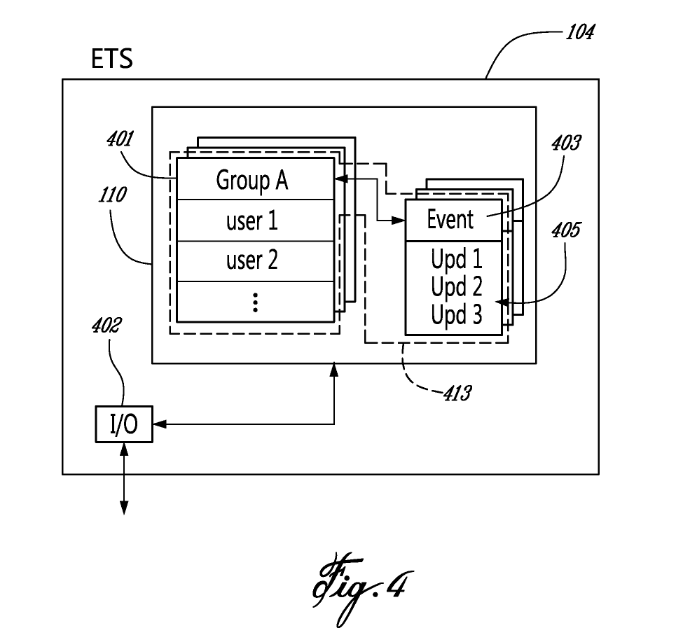

Reference is now made to FIG. 4, which is a high level block diagram of an exemplary implementation of the ETS 104 according to the preferred embodiment of the invention. The ETS 104 may comprise an ETS data repository 110 storing one or more group event instances. Each group event instance of the ETS 104 comprises at least a user group 401 and an event 403. Shown in FIG. 4 is for example a group event instance 413 comprising the group A of users linked to the event X. Optionally, the Event X may comprise further information 405 associated with the group event instance, such as for example update triggers Upd_1, Upt_2, and Upt_3, wherein each such update trigger defines a condition upon which the group event instance 413 of the ETS 104 gets notified of a change to its corresponding group event instance stored in the EOS 102. For example, the group event instance 413 of the ETS 104 may subscribe its corresponding group event instance 313 from the EOS 102 to be notified of any update using one or more of the following exemplary update triggers:
Upt_1 trigger: any change to the group event instance 313 of the EOS 102;
Upt_2 trigger: a change to the group of users (e.g. a member was added or deleted) related to the group event instance 313 of the EOS 102
Upt_3 trigger: a change to the event (e.g. a change in the time and/or place of the event) related to the group event instance 313 of the EOS 102

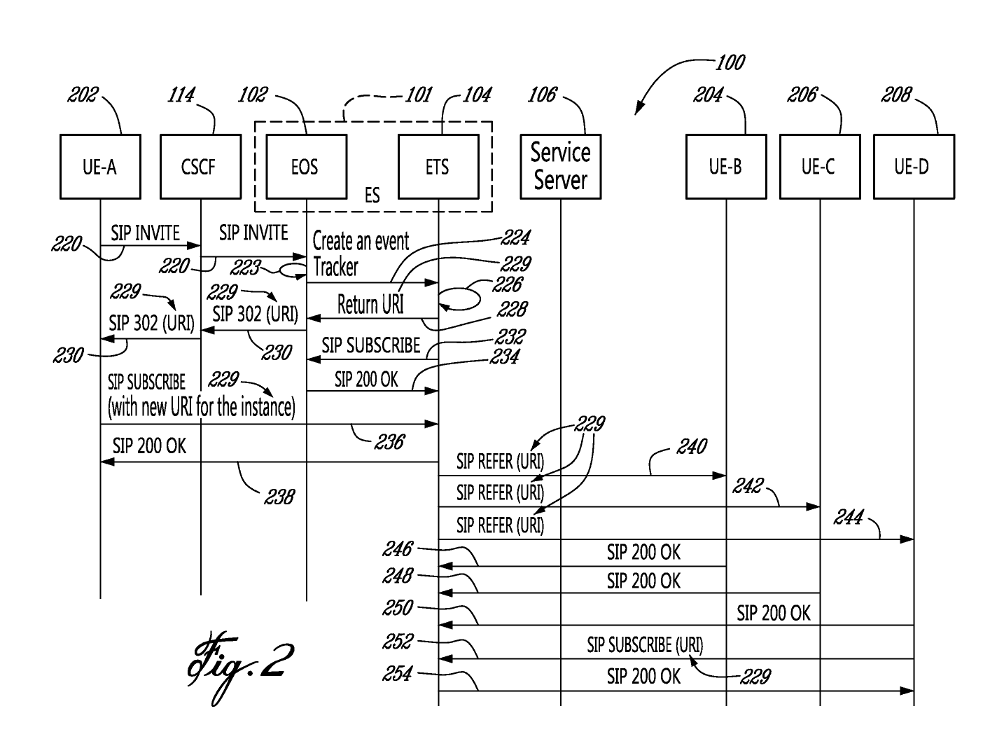

The ETS 104 further comprises an Input/Output communication interface 402 for communicating with the network 100 and other UEs as previously described, using for example SIP signalling. It is via the communication interface 402 that the ETS 104 performs the actions described in relation to FIG. 2, which are yet to be described. For example, the communication interface 402 subscribes with the EOS 102 to updates of a given group event instance and further receives from UEs subscriptions for the updates to the ETS' group event instances, and yet further receives from the EOS 102 update notifications related to the EOS' group event instances. The communication interface 402 also sends out update notification messages to each one of the users notifying of the ETS′ group event updates.

Reference is now made to FIG. 2 which shows a nodal operation and signal flow diagram illustrative of an exemplary implementation of the preferred embodiment of the invention in the IMS network 100. The network comprises the EOS 102 and the ETS 104 as described hereinbefore. One should also note however that according to a variant of the invention the EOS and ETS 102 and 104 may also be combined in a standalone system 101 (logically, functionally and/or physically collocated). However, in the exemplary preferred embodiment described hereinbelow, the EOS 102 and the ETS 104 are decoupled from each other as shown in FIG. 2 so that the ETS 102 is a standalone entity, at least logically, therefore providing for added flexibility to programmers and administrators for the personalization of services implemented in the ETS. For example, such a standalone ETS 104 may be personalized easier and services may be more easily implemented therein if programmers and administrators only need to update the ETS 104 with new functionalities and services, while the EOS 102 can be left untouched and in operation. Moreover, such an approach may allow various third parties to more easily develop and implement ETS-related functionalities that can cooperate and work with already implemented EOS functionalities and systems.

Shown in FIG. 2 are UEs A through D 202, 204, 206 and 208, and a CSCF 114 that acts as the port of entry for the UEs to the IMS network 101. Also shown in FIG. 2 are the EOS 102 and ETS 104, and a service server 106 such as for example a Location Guide Service 106 capable of providing location based services for the UEs 202-208. All UEs 202-208 are for the sake of the presently described scenario members of a group X, such as for example members of a hockey team. Still according to the presently described scenario, an event organizer, e.g. user of UE A 202, is the person who is responsible for scheduling the next hockey game (an event) against another team. User A, for example being the team coach, desires to set up an event tracker service for the team that will allow each member to receive update notifications informing of any change to the event i.e. to the match, or to the participants to the event, and further to allow each member of the team to communicate with each other. The present invention enables such a service.

For example, in order to create the event tracking service, the event organizer, user A, may start by initially sending a message 220 to the EOS 102 (it is herein assumed that the address of the EOS 102 used by UE-A 202 to initially contact the EOS 102 has been previously provisioned or is otherwise known to the UE-A 202). The message 220 may take the form of a SIP INVITE message and may include either a user group identifier or the full list of users (with their identities, e.g. phone numbers, email addressees, Uniform Resource Identifiers (URIs), etc) associated with a given user group, and the event information (e.g. event name, such as e.g. “our hockey match against team B”, event place, event time, etc). Alternatively, the message 220 may only comprise a reference to an event and/or a user group that is/are already defined in the EOS 102, without necessarily comprising the group's users, or the full event definition. For example, the user A (or someone else) may have pre-defined a series of events of interest (e.g. all the hockey matched of the season, with their venues and times), and/or one or more user groups in the EOS 102 using an Internet portal (not shown in FIG. 2). In such circumstances, the message 220 may only comprise the user group identifier and the event identifier. The message 220 is received via the CSCF 114 by the EOS 102. This triggers the creation 223 in the data repository 108 of the EOS 102 of a group event instance that associates a group of users with an event as indicated by message 220. In action 224, the EOS 102 requests the ETS 104 to create its own group event instance, identified by a group event instance identity possibly in the form “Group A Event X@EventTracking.com”, using the same information as indicated by the initial message 220. The ETS 104, in action 226, therefore creates its own group event instance in its data repository 110. As shown in FIG. 4, a group event instance is created in the ETS that links a group of users A with an event 403. Update triggers 405 are also preferably created, either by default (e.g. by default the group event instance of the ETS 104 is to be notified of any change related to the EOS' group event instance), or based on information contained in the message 220 that may specify, for example, specific update triggers only for changes to the event itself, and not for the group membership, or vice-versa).

With reference being made further to FIG. 2, once the group event instance is created in the ETS 104 in action 226, the ETS 104 informs the EOS 102 of the success of the action via the message 228 that comprises the URI 229 associated with the ETS′ group event instance. The EOS 102 then returns the group event instance URI 229 to user A, action 230. The ETS 104 further subscribes in action 232 with the EOS 102 for being notified of changes and updates to the group event instance of the EOS 102. Action 232 may preferably comprise the issuance of a SIP SUBSCRIBE message comprising the update triggers 405 that were set up in the group event instance of the ETS 104. Upon receipt of the SIP SUBSCRIBE message, the EOS 102 knows that it has to notify the ETS 104 every time a change that corresponds to the update triggers occurs to its own group event instance, and confirms this in action 234 to the ETS 104. At this point, the subscription session between the ETS 104 and the EOS 102 is established, so that every time an update corresponding to the update triggers involves the group event instance of the EOS 102, an update notification is sent to the ETS 104.

Once the subscription session is established between the ETS 104 and the EOS 102, for the users to be able to get notifications of group event updates, they further need to subscribe to such updates.

Therefore, according to the preferred embodiment of the invention, UEs A-D 202-208 also subscribe, or are caused to subscribe, with the ETS 104 for receiving group event instance updates. This may be achieved in several manners. First, for example, as illustrated for the subscription of the UE-A 202, the later may send a SIP SUBSCRIBE message 236 to the ETS 104, the message comprising the URI 229 of the group event instance of interest to UE-A (URI 229 that was received previously in action 230), in order to subscribe for receiving updates related to the ETS' group event instance. The UE-A 202 then receives back a confirmation of the subscription via a SIP 200 OK message 238. Alternatively, the ETS 104 may cause UEs associated with the group event instance to subscribe to the group event instance updates by sending SIP REFER messages 240-242-244 to the respective UEs, wherein the REFER messages comprise the URI 229 of the ETS' group event instance. Confirmation messages 246-248-250 for the SIP REFER messages are received back at the ETS 104. Thereafter, responsive to the SIP REFER messages 240-242-244 received by each one of the UEs B-C-D, the later send to the ETS 104 individual SIP SUBSCRIBE messages 252-256-260 comprising the URI 229 of the group event instance for subscribing to updates related to the ETS' group event instance. Confirmations of the subscriptions for updates regarding the ETS' group event instance are sent back to the UEs 204-206-208 via 200 OK messages 254-258-262. At this point, each one of the UEs A through D 202-208 has subscribed for group event instance updates with the ETS 104, and the ETS 104 also subscribed to receive updates to the corresponding group event instance from the EOS 104. In this manner, every time an update to the group event instance of the EOS 102 takes place, such an update is propagated from the EOS 102 to the ETS 104, and from there further to the UEs A through D.

In action 266 a change to the group event instance of the EOS takes place. This may occur in various manners. For example, the location or time of the event associated with the group event instance may get updated by one of the group users. Alternatively, a change in the membership of the group is performed by the event organizer. Such actions may be undertaken via an Internet portal (not shown) connected to the EOS 102. Alternatively, such a change may be sent via a SIP NOTIFY message 264, e.g. from the event organizer user A, wherein the message 264 comprises the update 265 to the EOS' group event instance. In the exemplary scenario shown in FIG. 2, the UE-A 202 alters, for example, information related to the group event in the EOS 102. This change is recorded in the group event instance of the data repository 108 of the EOS 102. Since the group event instance of the EOS 102 is altered, and because the group event instance of the ETS 104 has subscribed with the EOS 102 to be notified of any changes to that group event instance (see actions 232-234), a SIP NOTIFY message 268 is sent out from the EOS 102 to the ETS 104 notifying of the group event update 265 associated with the group event instance identified by the URI 229. Once the ETS 104 receives the update notification about the group event instance, it may also record the change in its own data repository 110, action 270.

Since the users A-D have subscribed for being notified upon any change of the ETS' group event instance, the next step is for the ETS 104 to send out update notifications to the end users. This may be performed either immediately after action 270, or by first personalizing the individual user notifications, e.g. based on each user's preferences or conditions, or location. In such an instance, the ETS 104 may first contact the service server 106 in order to get data that may be used for personalizing the user notifications. Such data may be associated for example with personal preferences in advertising, or with the location of each user. For example, a given user may chose to receive his/her own notifications along with advertisement on a given topic (e.g. hotels, or restaurants), or to receive the notification including a route from his/her current location to the location of the event of the group event instance. Thus, in action 272 the ETS 104 contacts the service server 106 with a request for additional data related to one or more users, and receives back in action 274 a service response comprising the requested data (e.g. ads, or location data as per the previous examples). A specific example of such personalization may be based on the location of the end users. For example, in action 272, the ETS 104 may inquire with a location service server 106 about the location of the end users and/or the route to the event's location, which it receives back in a location response message 274. The messages 272-274 may be performed only once if inquiring of the location of all UEs 202-208 at the same time, or may be individually performed for each UE. Another example is to obtain in action 272 a list of commercial places (e.g. hotels or restaurants) located in the neighborhood of the event, i.e. of the hockey match for example).

In action 276, 278, 280 and 282, the ETS 104 issues via its communication interface 402 update notification messages informing the end users of the change related to the ETS' group event instance. Such notification messages may take the form of SIP NOTIFY messages that may further include the personalization of actions 272-274 (e.g. the route to event destination, or advertisement related to the event). The SIP NOTFY messages may comprise the update to the group event instance, including but not being limited to the change in time or location of the event, or in the group user list associated with the group event.

According to the preferred embodiment of the invention, in action 284, the end users A-D may communicate with each other, using information received in the SIP NOTIFY messages 276-282. For example, one of the end users can issue then a SIP MESSAGE message destined to the group event instance URI 229 of the ETS 104 in order to communicate with the other group members. For example, the UE-C 206 may issue a SIP MESSAGE message 286 comprising the URI 229 of the group event instance that is sent out to the ETS 104 but is destined to the other group members. Upon receipt of the message 286, the ETS 104 determines based on the URI 229 of the group event instance that this is a message destined to the other users associated with the group event instance, and therefore relays the SIP MESSAGE message 286 in actions 288-290-292 to the other end UEs A, B, and D associated with the group event instance.

As it can be contemplated, the present invention provides a flexible 2-tier system for group event communications, wherein in a first layer herein called the EOS allows for group event definition, where a user group is associated with a given event, and wherein a second layer called herein an ETS subscribes to updates related to the group event with the EOS. As soon as such an update takes place in the EOS, the EOS notifies the ETS, which further notifies the users associated with the group event, since the users have subscribed with the ETS for receiving group event updates. Furthermore, according to the invention, the users associated with the group event instance are also able to communicate with each other by sending out message to the ETS' group event instance which acts as a hub or message distributor to all group members.

Based upon the foregoing, it should now be apparent to those of ordinary skills in the art that the present invention provides an advantageous solution, which efficient and flexible group event communications. Although the system and method of the present invention have been described in particular reference to certain exemplary scenarios and implementations, it should be realized upon reference hereto that the innovative teachings contained herein are not necessarily limited thereto and may be implemented advantageously with various scenarios, implementations, and applicable radio telecommunications standard. For example, while the illustrations of FIGS. 3.b and 4 show certain exemplary implementations of the EOS and ETS, it is to be understood that the invention can be implemented using other setups as well. For example, it is understood that the EOS and ETS may further comprise hardware and software means, or any combination thereof, as preferred in a certain implementation. In particular, the EOS and ETS may be implemented using computer system(s), each comprising one or more processors executing instructions that, when executed, cause the EOS and ETS to perform the actions described hereinbefore. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for group communications comprising the steps of:
a. subscribing with an Event Organizing System (EOS) to updates of a group event instance, the group-event instance comprising identification of a group of users and an event related to the group of users, said updates comprising changes to information related to the group event instance;
b. receiving from at least certain users subscriptions to the updates of the group event instance;
c. responsive to step a., receiving from the EOS an update notification related to the group event instance notifying of a group event instance update; and
d. responsive to step b., sending out an update notification message to at least the certain users notifying of the group event update.

2. The method claimed in claim 1, wherein the update notification message sent out to at least the certain users is a message that is personalized for each user.

3. The method claimed in claim 2, wherein the update notification message sent out to at least the certain users is a message that is personalised for each user based on each user's location.

4. The method claimed in claim 1, further comprising the step of:
e. prior to step d., receiving a message from the EOS creating a group event instance that triggers the step a., the group event instance comprising the identification of a group of users and the event related to the group of users.

5. The method claimed in claim 1, further comprising the step of:
e. prior to step b., sending out to the users a SIP REFER message that triggers step b.

6. An Event Tracking System (ETS) comprising:
a data repository comprising group event instances, wherein each group event instance comprises an identification of a group of users, and an event related to the group of users;
a communications interface operationally connected to the data repository and supporting communications with external nodes, the interface receiving, from at least certain users of a group, subscriptions for updates to a corresponding group event instance and, responsive thereto, sending out an update notification message to the certain users notifying of an update related to the group event instance.

7. The ETS as claimed in claim 6, wherein the communications interface sends out a message to subscribe with an Event Organizing System (EOS) to the updates of the group event instance, and responsive thereto receives from the EOS an update notification related to the group event instance.

8. The ETS claimed in claim 6, wherein the update notification message sent out to the certain users is a message that is personalized for each user.

9. The ETS claimed in claim 8, wherein the update notification message sent out to the certain users is a message that is personalised for each user based on each user's location.

10. The ETS claimed in claim 7, wherein the communication interface receives a message from the EOS creating the group event instance that triggers subscribing with the EOS for receiving updates of the group event instance.

11. The ETS claimed in claim 6 wherein the communication interface sends out to the users a SIP (Session Initiation Protocol) REFER message that causes to receive from the users subscriptions for the updates to the group event instance.
